(19) United States
(12) Patent Application Publication
(10) Pub. No.: US 2015/0329742 A1
(43) Pub. Date: Nov. 19, 2015

(54) Digitally Printable Topcoat

(71) Applicant: Avery Dennison Corporation, Glendale, CA (US)

(72) Inventor: James BAKER, Mentor, OH (US)

(21) Appl. No.: 14/711,688

(22) Filed: May 13, 2015

Related U.S. Application Data
(60) Provisional application No. 61/992,938, filed on May 14, 2014.

(51) Int. Cl. C09D 175/04; B05D 3/00; B05D 5/04

(52) U.S. Cl. CPC C09D 175/04; B05D 5/04; B05D 3/007

(57) ABSTRACT

A topcoat is described that can be applied or deposited using various printing techniques. The topcoat formulation includes solvated polyvinyl butyral, isocyanate or urethane prepolymer, and polyol.

### CROSS-REFERENCE TO RELATED APPLICATION

The present application claims the benefit of U.S. Provisional Application No. 61/992,938 filed on May 14, 2014, which is incorporated herein by reference in its entirety.

### FIELD

The present subject matter relates to topcoats, methods of forming and/or depositing topcoat formulations, and the resulting topcoated films or substrates.

### BACKGROUND

Piezoelectric deposited ink, or more commonly known as inkjet printing, has undergone several phases of evolution over the past few decades. Full solvent printing technology has been a workhorse in industry for large scale operations, but has left little opportunity for smaller scale needs. As newer ink technologies addressed the needs of these smaller scale, shorter printing runs, such as UV cured printing inks, mild solvent (Ecosolvent), and latex inks; unmodified cast organisol PVC film has been unable to meet current industry demands. Problems with inconsistent print quality, ink density, and shortened shelf life have created a need for a functional topcoat to address the constantly changing surface chemistry of films. The topcoat should provide printability and enhanced weatherability to the resulting coated films.

Functional topcoats are traditionally designed to add functionality to a low cost extruded, blown, or calendared film. The use of topcoats for cast organisol PVC film has become popular, as newer and faster printing technologies require balanced and homogeneous surface chemistry to print consistently. Although remedying various shortcomings of films, the topcoats must not create problems. This is a critical factor when choosing the resins and additives of which the topcoat is comprised. When choosing between waterborne and solvent borne polymer chemistries, the end use must be considered. While waterborne topcoats can provide low to zero emissions of volatile organic compounds (VOCs), their durability and cost must be weighed against the requirements of end use. Consistent manufacturability must also be taken into consideration, as waterborne coatings require tedious and time consuming manufacturing steps to be properly prepared for coating.

While solvent borne coatings are typically not VOC compliant, they are easily manufactured on reverse roll setups, and their evaporated solvents can be safely converted to carbon dioxide by thermal oxidizers. Higher solids solvent borne coatings benefit from both being fully solvated, while reducing the resulting carbon dioxide emissions in manufacturing. While low VOC coatings emit lower VOC content during drying on a coater, more natural gas is required to heat the ovens. Modern roll to roll coaters are heated partially or entirely by the combustion of solvents out gassed during solvent borne coating, in the thermal oxidizer system. When water borne fluids are coated and dried on a coater, no heat is generated from recycled solvent, which requires the thermal oxidizer to heat the ovens by burning natural gas. Thus, the assumed lower CO₂ emissions from waterborne coatings are offset by the excess CO₂ from burning natural gas that is required to heat the ovens and dry the coatings.

Filtration and de-gasification steps are critical for waterborne topcoats to be successfully reverse roll coated. Even if these steps are properly performed, a dirty or improperly prepared coating set-up can easily create coating and drying defects. Coating defects can also be created by the chemical characteristics of waterborne coatings, as they dry easily on air contact, and do not re-dissolve upon contact with water, or the predecessor coating solution. This can be a problem when coating. If dried material falls into the nip during coating, it would not re-dissolve as would a solvent borne coating. In a reverse roll, comma, or knife over roll coating set up, these particles would catch in the nip, forming streaks in the coating. Water borne coatings also suffer from excessive air entrapment problems during compounding. Due to emulsions and dispersions having a large particle size, along with the inherent low shear viscosity, air mixed in the fluid has a difficult time releasing when at rest. This air entrapment can be an issue during coating, as the entrapped air in the fluid forms lanes of concentrated air bubbles onto the casting web during roll to roll coating. Solvent borne coating solutions provide a more forgivable performance when used in roll to roll coating. They are easy to compound, as the polymer particles are fully solvated rather than being in a suspension. Gases mixed into the fluid during compounding are able to release much easier, as the particle size distribution is much lower. If dried particles fall into the fluid during coating, they have an easier chance of being re-dissolved. Solvent borne coatings are capable of forming high levels of coalescence, which improves resistance to chemicals and outdoor weathering.

In view of the foregoing, a need remains for a new class of solvent borne topcoat formulations which provide improved printability and enhanced weatherability.

### SUMMARY

The difficulties and drawbacks associated with previous approaches are addressed in the present subject matter as follows.

In one aspect, the present subject matter provides a topcoat formulation comprising (i) from 12% to 35% of at least one polyvinyl butyral, (ii) from 25% to 45% of at least one agent selected from the group consisting of isocyanates, urethane prepolymers, and combinations thereof, and (iii) from 32% to 52% of at least one polyol.

In another aspect, the present subject matter provides a method of forming a topcoat on a substrate. The method comprises providing a substrate defining a receiving face. The method also comprises providing a topcoat formulation including (i) from 12% to 35% of at least one polyvinyl butyral, (ii) from 25% to 45% of at least one agent selected from the group consisting of isocyanates, urethane prepolymers, and combinations thereof, and (iii) from 32% to 52% of at least one polyol. The method also comprises applying the topcoat formulation to the receiving face of the substrate. And, the method comprises performing at least one of curing and drying of the applied topcoat formulation to thereby form the topcoat.

In yet another aspect, the present subject matter provides topcoats on substrates, and particularly the topcoats formed by the methods described herein.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional view of a topcoated substrate in accordance with an embodiment of the present subject matter.

FIG. 2 is a schematic cross sectional view of a topcoated multilayer substrate in accordance with another embodiment of the present subject matter.

### DETAILED DESCRIPTION OF THE EMBODIMENTS

The present subject matter relates to topcoat formulations that can be used in a wide range of applications. The topcoat formulations include (i) solvated polyvinyl butyral with hydroxyl or other functionality, (ii) isocyanate or urethane prepolymer, and (iii) high molecular weight polyol. The formulations can also include other components such as (iv) UV resistance additives, and (v) crosslinking additives.

The present subject matter improves over traditional waterborne functional topcoats as being able to provide printability and shelf life stability, while improving ease of manufacturability. The improvement over waterborne topcoat technologies is attributed to the present topcoat formulations being fully solvent solution processable. Solvent solution processable coatings are easier and less expensive to manufacture, while providing higher quality film formation through complete coalescence. High levels of film coalescence provide better durability and outdoor weatherability.

In certain embodiments, the present subject matter provides durable and functional topcoats in a multilayer film, utilizing thermoplastics such as polyvinyl chloride (PVC), polyurethane, acrylic, and various crosslinked and uncrosslinked solvent cast and hot melt thermoplastics to serve as strengthening layers, providing tensile strength and tear resistance.

The present subject matter topcoat formulations can be directly coated, dried, and cured on an intended supporting substrate or film. The coatings can also be coated and dried on a temporary coating substrate, such as a paper or polymer based release liner. The coated face of this temporary construction can then be coated with subsequent functional layers, or can be laminated and bonded onto a permanent substrate or film construction. In both of the two noted strategies of construction above, the temporary coating substrate can be removed thereafter exposing the print receptive layer.

The topcoat formulations can incorporate polymer crosslinking in several different ways. The primary thermoplastic(s) in the formulation can be directly crosslinked with isocyanates, silanes, and/or metal chelate crosslinkers. While this crosslinking method modifies the polymer matrix for ideal print reception, this short chain crosslinking method tends to make the polyvinyl butyral brittle as a cohesive free film. The crosslinks are short in molecular length, allowing very little movement of the polymer chains.

To create a crosslinking network while maintaining flexibility and elasticity, the primary thermoplastics in the coating can be crosslinked with longer chain length, higher molecular weight crosslinkers. This method of crosslinking utilizes a solvated polyvinyl butyral with hydroxyl or functionality, an isocyanate or urethane prepolymer, and one or more high molecular weight polyols. The noted components are prepared in a generally homogeneous mixture, which are then coated and dried on a substrate. After coating and drying, the isocyanate and polyols begin to form long linear chains, of which a portion of those reactions then bonding to the hydroxyl groups on the polyvinyl butyral (PVB) molecule, with the remainder terminating into water or other contaminates. The resulting film will then be in the form of a highly entangled urethanized PVB structure. The longer chain crosslinks allow the main thermoplastic molecules to stretch and move more freely, creating a more flexible and elastic film.

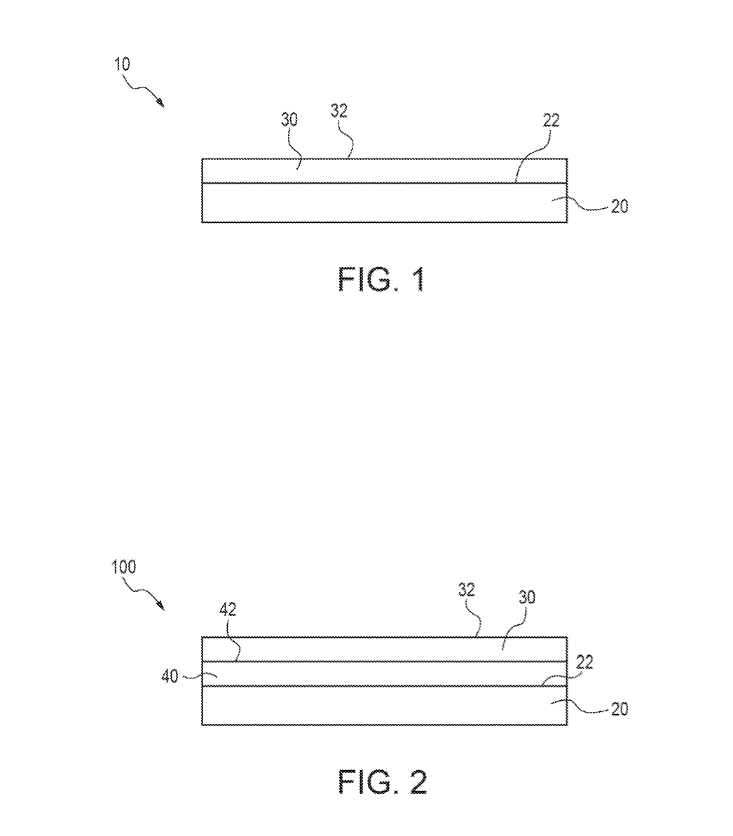

FIG. 1 is a schematic cross sectional view of a multilayer assembly 10 comprising one or more substrates or substrate layers collectively shown as 20, and a layer or region of a topcoat 30 disposed thereon. Specifically, the substrate(s) 20 define a surface or face 22 upon which the topcoat resides. In most embodiments, the multilayer assembly 10 defines an exposed face 32 of the topcoat 30 which can receive print or other graphic elements.

FIG. 2 is a schematic cross sectional view of another multilayer assembly 100 comprising one or more substrates or substrate layers collectively shown as 20, one or more topcoats or intermediate layers collectively shown as 40, and one or more additional topcoats or outer layers collectively shown as 30. Specifically, the one or more topcoats or intermediate layers 40 are disposed on a face 22 of the substrate(s) 20, and the one or more additional topcoats or outer layers 30 are disposed on a face 42 of the layer(s) 40. The exposed outer face 32 of the layer(s) 30 can receive print or other graphic elements.

Additional details and aspects of the topcoat formulations, multilayer films including the topcoats, methods related to such, and applications are described herein as follows.

### Topcoat Formulations

As previously noted, the present subject matter topcoat formulations comprise (i) one or more solvated polyvinyl butyral agents with hydroxyl or other functionality, (ii) one or more isocyanate and/or urethane prepolymer agents, and (iii) one or more high molecular weight polyols.

### Solvated Polyvinyl Butyral

Polyvinyl butyral (PVB) is also known as poly[(2-propyl-1,3-dioxane-4,6-diyl)methylene] and has a molecular formula of (C₈H₁₄O₂)ₙ. PVB can be prepared from polyvinyl alcohol by reaction with butyraldehyde.

In many embodiments of the present subject matter, the PVB is selected having a weight percentage of hydroxyl groups (in terms of polyvinyl alcohol) of from about 10% to about 28%, and more particularly from 12% to 24%.

In many embodiments the PVB is selected to include acetyl functionality. The weight percent of acetyl groups (in terms of polyvinyl acetate) typically is from about 1% to about 10%, and more particularly from 1% to 4%. In many versions of the present subject matter, the PVB includes a combination of hydroxyl functionality and acetyl functionality.

In many embodiments, the PVB is selected to exhibit a glass transition temperature (Tg) within a range of from about 55° C. to about 75° C., and particularly from 58° C. to 70° C.

The PVB is accompanied by one or more suitable solvents. In many embodiments, the PVB is solvated or dissolved in one or more solvents selected from alcohols such as methanol, ethanol, n-propanol, iso-propanol (IPA), n-butanol, sec-butanol, n-octanol, diacetone alcohol, benzyl alcohol, and combinations thereof; cellosolves such as methyl cellosolves, ethyl cellosolves, butyl cellosolves, and combinations thereof; ketones such as acetone, methyl ethyl ketone (MEK), cyclohexanone, isophorone, and combinations thereof; amides such as N,N-dimethyl acetamide, N,N-dimethyl formamide, N,N-methyl-2-pyrrolidone, and combinations thereof; ethers such as 1,4-dioxane, tetrahydrofuran (THF), and combinations thereof; certain chlorinated hydrocarbons such as methylene chloride, chloroform, and combinations thereof; aromatics such as toluene, pyridine, and combinations thereof; and other agents such as butyl acetate, ethyl acetate, dimethyl sulfoxide, acetic acid, terpineol, butyl carbitol, and combinations thereof. Combinations of one or more of these solvents can be used. In many embodiments, the solvent is selected from one or more of toluene, butyl acetate, ethyl acetate, methyl ethyl ketone, and combinations thereof.

PVB is commercially available from various suppliers. Nonlimiting examples of PVB which may be used in the topcoat formulations of the present subject matter include SEKISUI S-LEC-B PVB available form Sekisui Specialty Chemicals of Japan; and MOWITAL PVB available from Kuraray.

### Isocyanate or Urethane Prepolymer

A variety of isocyanates can be used in the present subject matter topcoat formulations. For example, the following isocyanate types can potentially be used: monoisocyanates, aliphatic diisocyanates, aromatic diisocyanates and polymeric isocyanates. Isocyanates that are not monoisocyanates are also called polyisocyanates. Monoisocyanates are used for monofunctional urethanes only. Diisocyanates are by far the most widely used in urethane synthesis. They are available in aliphatic and aromatic diisocynates. Aromatic diisocyanates are used for the manufacture of the so-called aromatic urethanes. The incorporation of an aromatic diisocyanate typically makes the resulting topcoat harder and gives it a better scratch resistance. Aromatic urethanes are also significantly lower cost than many aliphatic urethanes. One drawback of aromatic urethanes is that they tend to yellow and therefore they are less appropriate for long lasting applications on white or light colored substrates.

Aliphatic diisocyanates are used in aliphatic urethanes. Aliphatic urethanes are slightly more flexible than aromatic urethanes with the same functionality, a similar polyol modifier and at similar molecular weight. One advantage of aliphatic urethanes is the fact that they are virtually non-yellowing and therefore can be used for long lasting applications, on white or light colored substrates.

Polymeric isocyanates are used less for urethanes than diisocyanates. They are essentially used for higher functionality (e.g., 3 and higher) urethanes. Isocyanate-functional reactants are made from polyisocyanates reacted with a compound containing active hydrogen functionality with hydroxyl groups being typical, although mercaptan groups, amine groups, and carboxyl groups also can be used.

Polyisocyanates are conventional in nature and include, for example, hexamethylene diisocyanate, toluene diisocyanate (TDI), diphenylmethane diisocyanate (MDI), m- and p-phenylene diisocyanates, bitolylene diisocyanate, cyclohexane diisocyanate (CHDI), bis-(isocyanatomethyl) cyclohexane (H 6 XDI), dicyclohexylmethane diisocyanate (H 12 MDI), dimer acid diisocyanate (DDI), trimethyl hexamethylene diisocyanate, lysine diisocyanate and its methyl ester, isophorone diisocyanate, methyl cyclohexane diisocyanate, 1,5-napthalene diisocyanate, xylylene and xylene diisocyanate and methyl derivatives thereof, polymethylene polyphenyl isocyanates, chlorophenylene-2,4-diisocyanate, polyphenylene diisocyanates available commercially as, for example, MONDUR MR or MONDUR MRS, isophorone diisocyanate (IPDI), hydrogenated methylene diphenyl isocyanate (HMDI), tetramethyl xylene diisocyanate (TMXDI), hexamethylene diisocyanate (HDI), or oligomer materials of these materials such as a trimer of IPDI, HDI or a biuret of HDI, and the like and mixtures thereof. Combinations of various isocyanates can be used.

Similarly as with isocyanates, a wide array of urethane prepolymers can be used in the present subject matter topcoat formulations. The urethane prepolymer is an isocyanate-terminated prepolymer. Nonlimiting examples of isocyanate-terminated prepolymers include aromatic prepolymers and aliphatic prepolymers. Nonlimiting examples of aromatic prepolymers include toluene diisocyanate (TDI), methylene diphenyl diisocyanate (MDI), and p-phenylenediisocyanate (PPDI). Nonlimiting examples of aliphatic (and cycloaliphatic) prepolymers include 1,6-hexamethylene diisocyanate (HDI), 1-isocyanato-3-isocyanatomethyl-3,5k5-trimethyl-cyclohexane (isophorone diisocyanate, IPDI), and 4,4′-diisocyanate dicyclohexylmethane (H₁₂MDI or hydrogenated MDI). Certain agents such as TDI for example are known or referred to in the art as polyisocyanates and/or as urethane prepolymers. Combinations of urethane prepolymers can be used in combination with one or more isocyanates.

The isocyanate and/or urethane prepolymer agent(s) which can be used in the present subject matter topcoat formulations can be commercially obtained from one or more suppliers. Nonlimiting examples include DESMODUR IPDI Isocyanate from Bayer Coatings; and various prepolymers made from DESMODUR IPDI Isocyanate and DESMOPHEN high molecular weight polyester polyol. DESMOPHEN materials are described herein in association with the polyol agents.

### Polyol

With regard to the polyols which can be used when practicing the present subject matter, they can include any material that contains a reactive hydrogen atom and that would react with the isocyanate or isocyanurate group of the isocyanate agent or urethane prepolymer. These materials include hydroxyl functional acrylics, hydroxyl functional polyesters, hydroxy functional polyethers, polyamines, polyamides, short oil alkyds, caster oil, epoxy resins with secondary hydroxyl groups, phenolic resins, and hydroxyl functional vinyl resins. Combinations of these agents can be used. If necessary, one or more vinyl resins may be used to promote adhesion.

As previously noted, in many embodiments, the one or more polyol components are high molecular weight polyol components. The term “high molecular weight” as used herein with regard to the polyol agent(s) refers to a molecular weight within a range of from about 1,000 to about 6,500. However, it will be appreciated that the present subject matter includes the use of polyol(s) having molecular weights outside of this range.

One or more polyols that are commercially available can be used in the present subject matter topcoat formulations. For example, DESMOPHEN high molecular weight polyester polyol available from Bayer Coatings can be used.

The proportions of each of the (i) solvated polyvinyl butyral, (ii) isocyanate or urethane prepolymer, and (iii) polyols can be tailored to provide the desired properties and characteristics of the resulting topcoat. Table 1 presents typical and particular weight percentages based upon the total solids weight in the topcoat formulation.

TABLE 1
Proportions of Components in Topcoat Formulations

| Agent(s) | Typical (%) | Particular (%) |
|---|---|---|
| Polyvinyl Butyral | About 12-35 | About 23 |
| Isocyanate or Urethane Prepolymer | About 25-45 | About 35 |
| Polyol | About 32-52 | About 42 |

### Additional Components

The incorporation of reactive diluents may also be utilized to improve flow of the topcoat compositions. Such diluents include low molecular weight compositions with some type of a functional group(s) on the polymer chain and act to lower the viscosity of the material and are then polymerized into the coating as it cures. These agents, however, may increase the crosslink density of the topcoat to the extent that the topcoat becomes too brittle. Notwithstanding the above, upon reading the disclosure herein, one skilled in the art would be able to select such reactive diluents which are appropriate for the intended application.

Leveling additives may also be added to reduce the surface tension of the coating for improved flow. Examples of leveling additives which can be used when practicing the present subject matter include: FLUORAD FC-430 fluorochemical surfactant commercially available from 3M Industrial Chemical Products Div., St. Paul, Minn. and 57 ADDITIVE silicone additive commercially available from Dow Corning Corp., Midland, Mich. Other additives which can be included into the topcoat composition prepared in accordance with the present subject matter include: hindered amine UV stabilizers, hindered amine light stabilizers, UV absorbers, UV stabilizers, optical brighteners and de-foaming agents.

In addition to the above, the topcoat composition may have pigments and particularly metallic pigments incorporated therein. Examples of such pigments include: titanium dioxide, BLANC FIX (i.e., barium sulfate), zinc oxide, LITHOPONE (i.e., a mixture of zinc oxide and barium sulfate), and magnesium silicate. Other pigments such as color pigments can be included in the topcoat compositions.

Additional agents can be included in the topcoat formulations such as dyes, matting agents, and surfactants. Combinations of these with other additives are contemplated.

The one or more additives can be utilized in a wide range of proportions in the topcoat formulations. Typically, the total weight percent of additive(s) utilized in the topcoat formulation is from 0.1% to 1.0%, and in certain embodiments from 0.1% to 0.5%. However, it will be appreciated that the present subject matter includes the use of amounts of additives outside of these ranges.

### Methods

The present subject matter also provides various methods associated with the noted topcoats and topcoat formulations. For example, methods of using the topcoats are provided in which substrates such as polymeric films are coated with the noted topcoat formulations to form print receptive layers thereon, and/or protective coatings thereon. More specifically, a substrate that defines one or more regions or faces that are to receive print or other indicia or graphic elements is provided. A topcoat formulation as described herein is provided and deposited or otherwise applied onto the region(s) and/or face(s) of the substrate. Details as to deposition and/or application techniques are provided herein. After appropriate deposition and/or application of the topcoat, such as in forming a layer of the topcoat formulation on the substrate region or face, the deposited formulation is then at least partially dried and/or cured. In many embodiments of the present subject matter, the applied formulation is completely or substantially so, dried and/or cured. Drying and/or curing can be performed in a variety of fashions, such as for example by heating and/or exposure to UV radiation or electron beam. In many embodiments, thermal curing and/or drying is used. Additional details of drying and/or curing of the topcoat are provided below.

### Combining Topcoat Components

The topcoat formulations can be prepared by combining appropriate amounts of the (i) one or more solvated polyvinyl butyral agents, (ii) one or more isocyanate and/or urethane prepolymer agent(s), and (iii) one or more high molecular weight polyols. During or subsequent to combining the components, conventional mixing and/or blending techniques can be used. In certain embodiments, the resulting topcoat formulation is in the form of an emulsion, dispersion, or suspension. However, in many embodiments, the topcoat formulation is in the form of a homogeneous mixture.

### Applying Topcoat Formulation

The topcoat formulation can be applied to a desired surface or substrate using one or more of a variety of application techniques. Non-limiting examples of coating techniques include slot die, air knife, brush, curtain, blade, floating knife, gravure, kiss roll, knife-over-blanket, knife-over-roll, offset gravure, reverse roll, reverse-smoothing roll, rod and squeeze roll coating. It is also contemplated that other application techniques such as spraying or dipping could be used. For label products, the topcoat composition can be applied to the absorbent layer using any conventional technique or process, including without limitation, coating “on press” during the converting process (e.g., in concert with the processes of die-cutting, matrix stripping, etc.), coating off-press using a separate coater, and other application methods.

In general, the dry coat weights of the topcoat may range from about 1 to about 60 gsm (g/m²). Typically, the coat weight is within a range of from 5 to 60 gsm. In other embodiments, the dry coat weight may range from about 1 to about 40 gsm, and in yet a further embodiment, the dry coat weight may range from about 1 to about 20 gsm.

### Drying/Curing of Topcoat

As noted herein, after appropriate deposition or application of the topcoat formulation on a surface of interest, the topcoat formulation is typically subjected to one or more drying operation(s) and/or curing operation(s). In many embodiments, heating is used to dry and to cure the topcoat. During drying of the topcoat, all or a substantial portion of any solvent(s) in the topcoat formulation evaporate and/or removed from the topcoat deposited on the surface of interest. More specifically, in certain embodiments, a first drying/curing stage at elevated temperatures followed by a second drying/curing stage at ambient temperature is utilized. Typical time periods for the first stage include a time period of from about 30 seconds to about 20 minutes, and particularly from 1 minute to 5 minutes, with 2 minutes being used for many applications. Typical temperatures for the first stage include temperatures from about 120° F. to about 300° F., and particularly from 180° F. to 230° F., with 210° F. being used for many applications. In certain applications the first stage uses a combination of 2 minutes at 210° F.

The second stage can utilize holding or “dwelling” the topcoat at ambient temperatures for a time period of from about 6 hours to about 1 week, more particularly from 1 day to 4 days, and in certain embodiments for a time period of 3 days. The term “ambient temperature” as used herein refers to temperatures within a range of from about 65° F. to about 75° F., with 70° F. being typical.

### Applications

The present subject matter topcoats can be utilized on the viewing surface of films intended for vehicle, architectural, signage, and promotional graphics applications. The coatings of the present subject matter can be utilized on the viewing surface of retroreflective articles such as enclosed lens and prismatic sheeting. The present subject matter can be coated on polymeric films such as polyester, polypropylene, polyethylene including high density polyethylene (HDPE), and low density polyethylene (LDPE), and metalized plastic substrates to make print receptive films for durable and temporary labels in the healthcare, food, and beverage industry. In many embodiments the topcoats can be used to provide print receptive surfaces for inkjet printing including solvent inkjet printing, laserjet printing, and thermal transfer printing.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A topcoat formulation comprising:
from 12% to 35% of at least one polyvinyl butyral;
from 25% to 45% of at least one agent selected from the group consisting of isocyanates, urethane prepolymers, and combinations thereof; and
from 32% to 52% of at least one polyol.

2. The topcoat formulation of claim 1 wherein the polyvinyl butyral is present at about 23%.

3. The topcoat formulation of claim 1 wherein the at least one of isocyanates, urethane prepolymers, and combinations thereof is present at about 35%.

4. The topcoat formulation of claim 1 wherein the polyol is present at about 42%.

5. The topcoat formulation of claim 1 further comprising at least one solvent.

6. The topcoat formulation of claim 5, wherein the at least one solvent is selected from the group consisting of toluene, butyl acetate, ethyl acetate, methyl ethyl ketone, and combinations thereof.

7. The topcoat formulation of claim 1 wherein the polyvinyl butyral includes hydroxyl functionality.

8. The topcoat formulation of claim 7 wherein the polyvinyl butyral includes from 10% to 28% hydroxyl groups.

9. The topcoat formulation of claim 1 wherein the polyvinyl butyral includes acetyl functionality.

10. The topcoat formulation of claim 9 wherein the polyvinyl butyral includes from 1% to 10% acetyl groups.

11. The topcoat formulation of claim 1 wherein the at least one polyol has a molecular weight in a range of from 1,000 to 6,500.

12. The topcoat formulation of claim 1 wherein the topcoat formulation further comprises:
at least additive selected from the group consisting of pigments, dyes, matting agents, surfactants, flow additives, leveling additives, and combinations thereof.

13. A method of forming a topcoat on a substrate, the method comprising:
providing a substrate defining a receiving face;
providing a topcoat formulation including (i) from 12% to 35% of at least one polyvinyl butyral, (ii) from 25% to 45% of at least one agent selected from the group consisting of isocyanates, urethane prepolymers, and combinations thereof, and (iii) from 32% to 52% of at least one polyol;
applying the topcoat formulation to the receiving face of the substrate;
performing at least one of curing and drying of the applied topcoat formulation to thereby form the topcoat.

14. The method of claim 13 wherein the at least one of curing and drying is performed by a first stage at elevated temperatures followed by a second stage at ambient temperatures.

15. The method of claim 14 wherein the first stage is performed for a time period of from 30 seconds to 20 minutes, and at a temperature of from 120° F. to 300° F.

16. The method of claim 14 wherein the first stage is performed for a time period of from 1 minute to 5 minutes, and at a temperature of from 180° F. to 230° F.

17. The method of claim 14 wherein the first stage is performed for a time period of 2 minutes, and at a temperature of 210° F.

18. The method of claim 14 wherein the second stage is performed for a time period of from 6 hours to 1 week, and at a temperature of 65° F. to 75° F.

19. The method of claim 14 wherein the second stage is performed for a time period of from 1 day to 4 days, and at a temperature of 65° F. to 75° F.

20. The method of claim 14 wherein the second stage is performed for a time period of 3 days, and at a temperature of 70° F.

21. A topcoat on a substrate formed by a method of claim 13.

22. The topcoat and substrate of claim 21 wherein the substrate is selected from the group consisting of polyester film, polypropylene film, polyethylene film, metalized plastic substrates, and combinations thereof.

23. The topcoat and substrate of claim 21 wherein the substrate is selected from polyvinyl chloride, polyurethane, acrylic, and combinations thereof.
